(19) United States
(12) Patent Application Publication
(10) Pub. No.: US 2013/0079508 A1
(43) Pub. Date: Mar. 28, 2013

(54) FILTER SYSTEM, IN PARTICULAR FOR VISCOSE FILTRATION

(71) Applicants: Enrico Mahlig, Cologne (DE); Dirk Stocker, Freudenberg (DE); Bernd Lubitz, Remscheid (DE)

(72) Inventors: Enrico Mahlig, Cologne (DE); Dirk Stocker, Freudenberg (DE); Bernd Lubitz, Remscheid (DE)

(21) Appl. No.: 13/627,032

(22) Filed: Sep. 26, 2012

Related U.S. Application Data
(63) Continuation of application No. PCT/EP2011/001563, filed on Mar. 29, 2011.

(30) Foreign Application Priority Data
Mar. 31, 2010 (DE) 10 2010 013 507.0

(51) Int. Cl. B01D 29/13; B01D 29/66; C08B 9/06

(52) U.S. Cl. CPC B01D 29/13; C08B 9/06; B01D 29/66
USPC 536/61; 210/483; 210/484; 210/411

(57) ABSTRACT

The invention relates to a filter having a layer which is permeable to a medium to be filtered, comprising at least one nonwoven part, wherein the nonwoven part withstands higher mechanical loads. According to the invention the layer comprises, in addition to the nonwoven part, at least one sheet-like support part connected to at least one sub-region of at least one side of the nonwoven part.

The present invention relates to a filter system having at least one layer that is permeable for a medium that is to be filtered comprising a nonwoven part as well as a use of the same and a device and method for the filtration of viscose.

Filter systems of the type as stated in the introduction are particularly suited for use in viscose filtration. However, such filters are also expedient for use in other types of filtration.

A filter device for the continuous filtration of viscose is disclosed in DE 2 006 685 A1. Using two semi-shells, from the outside, a filter material is mounted over a perforated hollow cylinder. The filtration takes place from the inside to the outside. Continuous operation is enabled by a backflushing arm that rotates around the longitudinal axis of the hollow cylinder and that is fastened on the inside. Due to a suction occurring inside the backflushing arm, medium that is to be filtered is partially cleaned in the countercurrent flow. The hollow cylinder has a perforation and must be completely flush with the two semi-shells, which is why the construction of the device as specified in DE 2 006 685 A1 is very complex, particularly with regard to the arrangement of the bore holes constituting the perforation.

Furthermore, EP 0 058 656 B1 discloses a filtration apparatus intended for the purpose of viscose filtration. The same includes a perforated hollow cylinder that supports the filter medium. A clamping jacket holds the filter medium in place on the hollow cylinder. A conical perforation of the cylindrical filter basket ensures, on the one hand, sufficient stability of the same and, on the other hand, maximum utilization of the filter medium.

Due to its better permeability with the same filter fineness, metal-fiber nonwoven fabric has become the preferred choice over wire meshes as a filter material in viscose filtration. A metal-fiber nonwoven fabric of this type constitutes a layer that rests against a supportive backing such as, for example, a perforated hollow cylinder, which is also referred to as a perforated basket, and that is held in place on the hollow cylinder, constituting a backing layer, by a clamping jacket in order to achieve a hold, and wherein the clamping jacket can be made, for example, of any type of fabric, perforated sheet metal or interconnected longitudinally arranged wires.

To increase the rigidity of the metal-fiber nonwoven fabric, the same is typically connected to a metallic fabric, particularly by means of sintering.

A particular disadvantageous aspect of such filter layers, which include a metal-fiber nonwoven part with a metallic fabric on at least one side of the same being disposed thereon and connected thereto, is that stress concentrations can occur, in particular, at the warp-end locations resulting in the mechanical destruction of the metal-fiber nonwoven part upon the implementation of cyclical filtration and backflushing operations. This occurs, in particular, if the filtration pressure is increased in an effort to increase the efficiency of a corresponding filtration system. To withstand said increased filtration pressure, the metal-fiber nonwoven layer is mounted with greater force on the perforated hollow cylinder constituting the support layer such that there occurs a direct transfer of stress concentrations from the metallic fabric to the warp-end locations on the metal-fiber nonwoven fabric. This also occurs during the backflushing operation for the purpose of cleaning the viscose filtration device. The mechanical destruction of the metal-fiber nonwoven part is exacerbated even further when an intermediate layer, also of a metallic fabric, is inserted between the perforated hollow cylinder constituting the support layer and the metal-fiber nonwoven layer having the metallic fabric connected thereto, which is directed away from the support layer. Providing such an intermediate layer is typically necessary because, in particular, due to the cyclical motion of the interconnected layers constituting the filter, during the filtration and backflushing operations, shear stresses of the metal-fiber nonwoven part would be generated at the perforations of the hollow cylinder, also resulting in a destruction of the metal-fiber nonwoven layer. In addition, it would be advantageous for a filter layer to be mounted on the backing/support body/supporting layer (in particular, over a perforated basket) at a higher tensile force in order to achieve a throughput that is as high as possible and the related higher differential pressure, in particular, during viscose filtration. However, due to the fact that the sintered metal-fiber nonwoven part has visibly less stretch in comparison to a metal fabric used as support material, at high tension forces, the metal-fiber nonwoven part becomes detached from the metallic fabric functioning as support material, thereby resulting in the destruction of the filter. Finally, in particular, when filter systems that are known from the prior art are used in connection with devices for viscose filtration that are configured, in particular, as automatic backflush filters, there is the problem that, should undercuts be present, in particular, at warp-end locations, even with backflushing, especially gel-type particles or other solid materials stay behind in the filter material,

whereby the efficiency of, in particular, automatic backflush filters that are used for viscose filtration is reduced.

Correspondingly, the object of the present invention resides in providing a filter system that at least reduces the mechanical destruction of a metal-fiber nonwoven layer in comparison to embodied examples that are known from the prior art.

Said object is achieved with a filter system of the type as stated in the introduction comprising at least one nonwoven part and at least one support made of an expanded metal or perforated sheet metal, which is welded or sintered to at least a partial region of at least one side of the nonwoven part and at least one further layer, wherein the support part is disposed on one side of the nonwoven part that is directed away from the support layer or toward the same. Within the meaning of the present invention, the connection between the nonwoven part and the support is achieved by welding or sintering, wherein it is further preferred for the nonwoven part to be sintered to the support part. The concept of connection within the meaning of the present invention therein is the presence of a solid connection of any type between the nonwoven part and the support part, whereby an overall, single-piece permeable layer is achieved. It is not precluded within the meaning of the invention, however, that the nonwoven part and the support part can be separated from each other again at a later time.

The support part is an expanded metal part or a perforated sheet metal, particularly preferred is an expanded metal part. In a further preferred embodied example, the support part is flat-rolled, particularly a flat-rolled expanded metal part. It is especially advantageous regarding the use of, in particular, a flat-rolled expanded metal that, due to the then-absence of any undercuts, it is possible to ensure better backflushing properties when the filter system according to the invention is used in viscose manufacturing, particularly during use inside a backflush filter, particularly an automated backflush filter, because solid particles, in particular, can be removed more efficiently during backflushing, particularly also the gel particles that occur during viscose filtration.

Using a flat-rolled expanded metal part, in particular, will increase the contact area for sintering between the metal-fiber nonwoven part and the expanded metal to almost the area enclosed by the expanded metal. With the use of a wire mesh as support part according to the prior art, on the other hand, sintering with the metal-fiber nonwoven part only takes place at the protruding warp-end locations.

Due to the clearly larger contact area for the sintering process, higher tension forces can be applied when the support/support body/supporting layer (particularly a perforated basket) is mounted without the metal-fiber nonwoven part becoming detached from the support part.

Providing, as a filter layer, a composite constituted of a nonwoven part and a support part, configured as an expanded metal part or perforated sheet metal, avoids altogether or at least reduces stress concentrations as known from the prior art in connection providing composites of metallic meshes and metal-fiber nonwoven parts. The more or less plane surface, particularly of a flat-rolled expanded metal and/or perforated sheet metal results at least in a reduction of the stress concentrations, particularly with increased throughput of the medium that is to be filtered. Ultimately achieved is a longer life span of the filter layer comprising the nonwoven part in that any mechanical destruction of the nonwoven part of the same is reduced. Moreover, the subject-matter of the present invention allows for the application of considerably higher tension forces that are applied by a clamping jacket. Higher filtration or backflushing pressures are rendered possible with the filtration of viscose, in particular.

If the support part is made of expanded metal, the void length thereof is preferably in the range of approximately 0.08 mm to approximately 5 mm in the unrolled state, preferably in a range of approximately 0.4 mm to approximately 4 mm, more preferably in a range of approximately 0.5 mm to approximately 2.5 mm. The expanded metal part preferably has a void width in the range of approximately 0.04 mm to 4 mm, preferably in a range or approximately 0.2 mm to approximately 3.8 mm, more preferred in a range of approximately 0.8 mm to approximately 1.8 mm in relation to an unrolled expanded metal. The bar width of an unrolled expanded metal part is preferably 0.08 mm to approximately 2.5 mm, preferably approximately 0.1 mm to approximately 2 mm, preferably approximately 0.15 mm to approximately 0.5 mm. Preferably, the porous support part has a strength (also: bar thickness) in a range of approximately 0.1 mm to approximately 3 mm, preferably approximately 0.12 mm to approximately 2 mm. The bar thickness and the bar width of the unrolled expanded metal that is used according to the invention are preferably equal therein, meaning the thickness of the bar is within the preferred ranges as stated previously with regard to the specified preferred ranges for the bar width. Advantageously, the flat-rolled, meaning the calendered expanded metal part, has a void length in a range of approximately 1.5 mm to approximately 2.5 mm, more preferred approximately 2.3 mm, and a void width in a range of approximately 1 mm to approximately 2 mm, more preferred in a range of approximately 1.2 mm to 1.8 mm.

The bar width and the bar thickness of the calendered expanded metal that is used according to the invention is preferably in a range of approximately 0.2 mm to approximately 0.5 mm, more preferred in a range of approximately 0.2 mm to approximately 0.4 mm. The sheet-metal-type support part preferably has a free cross-section in a range of approximately 15% to approximately 70%, preferably in a range of approximately 30% to approximately 65%, both in the unrolled as well as the rolled state. The free cross-section F_{q} [%] is calculated according to the formula

$${F}_{q} = ( 1 - \frac{2 B}{W} ) \cdot 100 \%$$

wherein B constitutes the bar width and W the void width (see FIG. 2).

The expanded metal that is especially advantageously used in the filter system according to the invention but also in the device as well as the method according to the invention, as described below, is advantageously calendered to a strength that matches the bar thickness of the unrolled expanded metal and/or exceeds the bar thickness of the unrolled expanded metal part only by up to approximately 50%, more preferred up to approximately 40%, still more preferred up to approximately 35%. For example, an unrolled expanded metal part having a bar thickness of approximately 0.3 mm can be calendered to approximately 0.3 mm to approximately 0.45 mm, more preferred to approximately 0.4 mm.

Further preferred, the flat-rolled expanded metal that is advantageously used in the filter system of the device according to the invention and the method according to the invention has a throughflow, at a differential pressure of 200 Pa, particularly with calendering to approximately the bar thickness or, however, to a value in excess of the same by approximately 50%, preferably approximately 40%, more preferred up to approximately 35% of the bar thickness, in a range of approximately 3,000 l/(dm²*min) to approximately 4,000 l/(dm²*min), more preferred in a range of approximately 3,200 l/(dm²*min) to approximately 3,700 l/(dm²*min). It is especially preferred, at a differential pressure of 200 Pa, for the throughflow of an expanded metal part that is calendered to approximately the bar thickness and that is preferably used for viscose filtration, more preferred in a backflush filter, still more preferred in an automatic backflush filter, to be in a range of approximately 3,200 l/(dm²*min) to approximately 3,500 l/(dm²*min).

The expanded metal part that is used therein, and which is preferably flat-rolled, has a preferred void length that is in a range of approximately 1.8 mm to approximately 2.15 mm and a void width that is in a range of approximately 1.35 mm to approximately 1.65 mm, a bar thickness that is in a range of approximately 0.2 mm to approximately 0.4 mm and a bar width in the same range as specified for the bar thickness. Within the meaning of the present invention, the throughflow is detected with an air permeability testing instrument FX 3300 lab tester III manufactured by the company Textest Instruments in compliance with DIN EN ISO 9237 using a testing area of 20 cm² and a differential pressure of 200 Pa.

Preferably, the permeable layer, which is made of a nonwoven part and an expanded metal part, has a throughflow, measured at 200 Pa differential pressure, that is in a range of approximately 40 l/(dm²*min) to approximately 900 l/(dm²*min), more preferred in a range of approximately 100 l/(dm²*min) to approximately 800 I/(dm²*min).

It is especially preferred in an alternate embodied example of the present invention for the filter system to have a layer comprising at least one nonwoven part and at least one support part of expanded metal, which is welded or sintered to at least one partial region of at least one side of the nonwoven part, wherein the expanded metal is flat-rolled and has a void length is in a range of approximately 1.8 mm to approximately 2.2 mm, a void width in a range of approximately 1.3 mm to approximately 1.6 mm and a bar thickness as well as a bar width in the range of approximately 0.2 mm to approximately 0.4 mm, with a throughflow, at a differential pressure of 200 Pa, that is in a range of approximately 40 l/(dm²*min) to approximately 900 I/(dm²*min), more preferred in a range of approximately 100 I/(dm²*min) to approximately 800 l/(dm²*min), which is used in viscose filtration, particularly in backflush filters, particularly in automatic backflush filters. Filter systems as described above allow for avoiding pressure concentrations in the construction when the device is mounted on a support/support body/supporting layer such as, for example, a perforated basket, on the one hand, particularly of automatic backflush filters, particularly for viscose filtration, while, on the other hand, achieving an increase in rigidity and solidity due to a reduction of the shearing between the support/support body/supporting layer, which is constituted, for example, as a perforated basket, and the nonwoven layer or, for example, an intermediate layer, preferably configured as a flat-rolled expanded metal part, that is disposed between the support layer, which is configured as a perforated basket, and the side of the nonwoven layer of the filter system. Such a filter system has, furthermore, excellent backflushing properties, particularly in connection with viscose filtration using backflush filters.

If the support part is made of expanded metal, the shape of the void can be a rhomboid void, an oblong void, hexagonal void, round void, square void or even a specially designed void, wherein rhomboid or square void configurations are preferred. Within the meaning of the present invention, preferably, an expanded grating with square voids is flat-rolled, meaning calendered, and used. If the support part is configured as a perforated sheet metal, the same can have a considerable variety of hole shapes such as, for example, a round perforation, a square perforation, a hexagonal perforation, an oblong perforation, a decorative perforation or any other specially designed type of perforation, wherein a round perforation is especially preferred.

Preferably, the nonwoven part within the meaning of the invention is an oriented and/or randomly laid-down nonwoven fiber mat part. The fibers of the nonwoven part therein are connected to each other, preferably, by a thermal treatment, preferably sintering. In a further preferred embodied example of the present invention, the nonwoven part itself is configured as having multiple layers consisting, preferably, of one or multiple randomly laid-down nonwoven fiber mats. In a further preferred embodied example, the fibers that are used in the nonwoven part, particularly randomly laid-down nonwoven fibers, can have varying fiber diameters. In a further preferred embodied example of the present invention, the randomly laid-down fibers have, in a multiple-layered configuration of the nonwoven part, different fiber diameters of the randomly laid-down fibers between layers but similar fiber diameters within the respectively same layers. The fiber diameters fluctuate by a mean value with deviations of ±10%. A fiber-oriented nonwoven part within the meaning of the present invention is such a nonwoven part with the fibers thereof arranged in one direction or in a cross-wise fashion, wherein a cross-wise arrangement is preferred within the meaning of the invention.

The material for the nonwoven and for the support parts can be selected depending on the application; a person skilled in the art thus addressed herein is easily able to select suitable materials based on his expert knowledge. It is especially preferred for the support part and/or the nonwoven part to be constituted of a material from a group comprising alloys containing iron and/or nickel. Examples for alloys on nickel basis are Hastelloy or Inconel; however, also possible are steel varieties such as chromium-nickel steel. Preferred iron-containing materials are alloys such as AISI 304L (1.4306), AISI 316L (1.4404), AISI 904 (1.4539), Inconel 600 (2.4816), Inconel 625 (2.4856), Monel 400 (2.4360) and Hastelloy B, X as well as C. The fibers that are used in the nonwoven part, preferably, have diameters in the range of approximately 0.1 to approximately 250 μm, preferably approximately 1.8 μm to approximately 25 μm, and a length of approximately 0.5 mm to approximately 100 mm, preferably in the range of approximately 2 mm to approximately 60 mm.

In addition to the first layer, comprising the nonwoven part and the support part, the filter system according to the invention comprises at least one further layer. Said further layer can be configured, for example, as an intermediate layer or, alternatively, as an outer layer constituting a clamping jacket; according to the invention, the intermediate layer is a supporting layer, meaning, for example, a hollow cylinder with perforations or a perforated jacket as part of a perforated basket. According to the invention, the support part, which is disposed only on one side of the nonwoven part, is directed away from a further layer that is configured as a supporting layer, particularly in form of a perforated hollow cylinder or a perforated jacket as part of a perforated basket. In a further preferred embodied example, the filter according to the invention has, in addition, at least one intermediate layer, preferably constituted of an expanded metal part, more preferably of a flat-rolled expanded metal part and/or at least one outer layer constituting a clamping jacket. The intermediate layer therein can be disposed between the supporting layer and the side of the nonwoven part constituting the layer of the nonwoven part and the support part, whereby, though, the outer layer comes to rest on the side of the support part side of the layer constituted of the nonwoven part and the support part and/or the intermediate layer. Preferred therein is a configuration of a layer comprising the nonwoven part and the support part that provides for the support part to be disposed only on one side of the nonwoven part. The intermediate layer can be welded or sintered to the nonwoven part; however, it is also possible for it to rest loosely against the nonwoven part.

An especially preferred embodied example of the present invention provides for a filter system that has at least four layers such as comprising a support layer, a subsequent intermediate layer of an expanded metal, preferably flat-rolled, a subsequent layer constituted of the nonwoven part and support part, which is directed with the side of the nonwoven part toward the intermediate layer as well as an outer side, wherein the outer layer is preferably configured as a clamping jacket. Within the meaning of the invention, it is not precluded therein that the nonwoven part comprises, for example, multiple layers, particularly randomly laid-down nonwoven fibers, particularly such of different diameters. Due to the fact that the intermediate layer is, preferably, an expanded metal that can be, in terms of its area, completely or partially disposed on the supporting layer, the development of stress concentrations during operation of the filter according to the invention is counteracted as well. The expanded metal part of this intermediate layer therein is preferably also configured such as described above in connected with the support part, and it is, preferably, flat-rolled.

Furthermore, the present invention relates to a use of the two-layer filter system according to the invention or, however, in the alternate embodied example, to a filter system having at least one layer comprising at least one support part of a flat-rolled expanded metal and at least one nonwoven part, as described previously, for viscose filtration, wherein use of the filter system according to the invention is not precluded in connection with other filtrations, as well as a device for the filtration of viscose, as described below according to the invention, comprising the at least two-layer filter system according to the invention or the alternately configured filter system having at least one support part that is connected to at least one partial region of at least one side of the nonwoven part for in order to constitute a layer that is permeable for a material, as described above.

The present invention finally also relates to a method for the filtration of viscose, wherein a medium that is to be filtered, particularly a fluid medium with viscose, is supplied to a device, filtered by a filter system according to the invention, allocated to the device, and circulated out of the device. The device therein can be a perforated basket or a perforated hollow cylinder of a filtration system, and wherein the perforated hollow cylinder and/or the perforated basket includes corresponding supply means for the medium that is to be filtered. In particular, when the device is configured as a perforated hollow cylinder and/or a perforated basket and the perforated region of the same is provided with a filter system according to the invention that includes as an intermediate layer a rolled expanded metal part and otherwise a nonwoven part that is sintered to the perforated sheet metal or expanded metal part, preferably flat-rolled expanded metal, wherein, more preferably, the intermediate layer is also welded or sintered to the nonwoven part, preferably sintered, stress concentrations are avoided even at high filtration or backflush pressures in the context of the method according to the invention, whereby the performance capacity of the method according to the invention is a considerable improvement in comparison to methods known from the prior art.

Advantageously, the device that is used for the filtration of viscose is configured as a backflush filter, more preferred as an automatic backflush filter.

It is especially preferred for the medium that is to be filtered to be supplied to the filter system disposed inside the device according to the invention at a temperature in the range of 10° C. and approximately 55° C., more preferred in a range of approximately 15° C. to approximately 45° C.

More preferred for viscose filtration is the use of a flat-rolled expanded metal part, more preferred flat-rolled to a thickness that corresponds to the bar thickness of the unrolled expanded metal part having a throughflow that is, measured at a differential pressure of 200 Pa, in a range of approximately 3,000 l/(dm²*min) to approximately 4,000 l/(dm²*min), more preferred in a range of approximately 3,200 l/(dm²*min) to approximately 3,700 l/(dm²*min); more preferred is a layer that includes at least one nonwoven part and at least one support part of expanded metal, particularly flat-rolled, with a throughflow, at a differential pressure of 200 Pa, in the range of approximately 40 l/(dm²*min) to approximately 900 l/(dm²*min), more preferred in a range of approximately 100 l/(dm²*min) to approximately 800 l/(dm²*min).

Advantageously, utilizing the method according to the invention, particularly in the context of viscose filtration with backflush filters, it is possible to achieve minimal differential pressures with low backflush volumes despite frequent backflush action.

These and further advantages of the present invention will be illustrated in further detail below based on the subsequent figures. Shown are in:

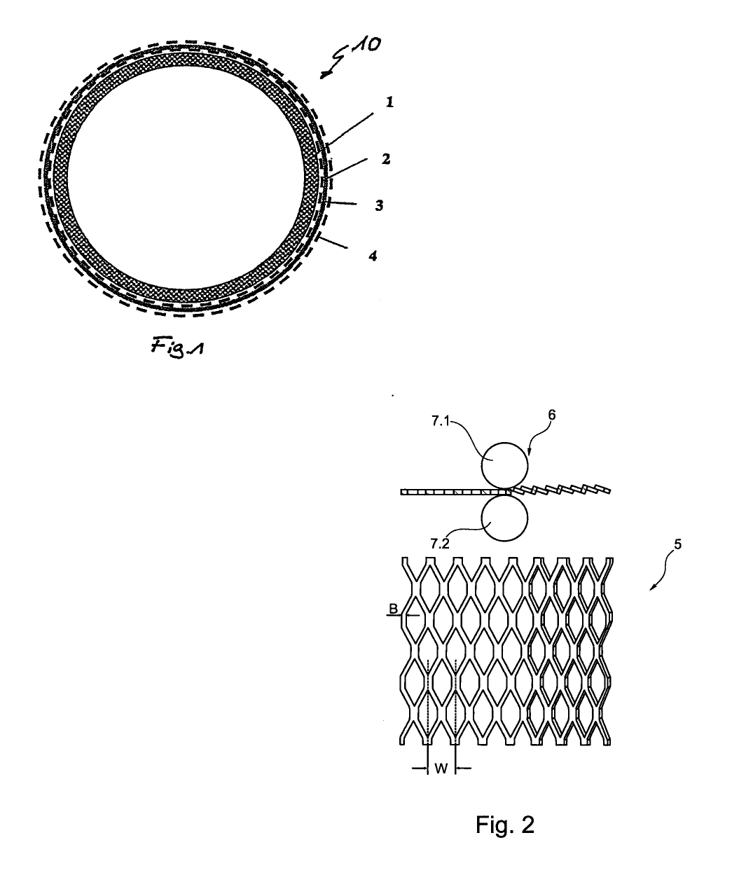

FIG. 1: a cross-section of a filter system according to the invention with a four-layered structure for viscose filtration; and in

FIG. 2: a flat-rolled expanded metal part, as it can be used in the context of the filter system according to the invention.

First, it should be noted that the invention is not limited to the combinations of characterizing features as demonstrated in the figures. Rather, any characteristics as disclosed in the description, including the explanation of the figures, can be combined with characteristics seen in the figures. In particular, the embodied example of a filter according to the invention as shown in FIG. 1, which shows a four-layered configuration, is only one of the embodied examples that are possible;

the same applies for the use of expanded metal as demonstrated in FIG. 2, which is only one possibility among several options. For example, the same can also have other shapes of voids in the mesh than as shown therein, while the filter according to the invention can also be configured, contrary to FIG. 1, not only as a perforated jacket but also, for example, with a plate-type, etc. configuration. Moreover, it is also possible to envision disposing an intermediate layer 2 between a nonwoven side of a layer 3, consisting of the nonwoven part and support part, and an outer layer 4. Finally, it is also to be noted that the reference symbols as included in the claims are in no way intended to limit the scope of protection of the present invention; instead, they are only intended as references for the embodiments as set forth in the figures. In particular, within the meaning of the present invention, a filter system according to the invention shall be configured in a single-layer with a layer that is permeable for the medium that is to be filtered, having at least one nonwoven part and at least one support part, and wherein the carrier part is preferably configured as a flat-rolled expanded metal part.

FIG. 1 shows a cross-section of a filter system 10 according to the invention for the filtration of viscose. The same has a perforated jacket 1 as a support layer, wherein this perforated jacket can be configured, for example, as specified in EP 0 058 656 B1. In particular, the perforation of the perforated jacket, which serves as a supporting layer within the meaning of the invention, can be executed having cone-shaped bore holes. However, other types of perforations can also be provided, for example, grooves that are arranged in parallel and horizontal directions and/or grooves that extend cross-wise having a triangular, trapezoid or semi-circular profile, and wherein, preferably, these grooves are provided with bore holes arranged at regular intervals that allow the fluid to pass.

An intermediate layer 2 consisting of a flat-rolled expanded metal, which covers at least the entire perforated surface of the supporting layer 1 is applied to the outer side of the supporting layer 1. The expanded metal part of the intermediate layer 2 therein is configured in the same way as the expanded metal part of layer 3. Reference is made to the details provided in the context therein.

Disposed as following the intermediate layer 2 is a layer 3 consisting of a nonwoven part and an expanded metal part as a support part. The expanded metal part therein is disposed on the side of the nonwoven part that is directed away from the supporting layer 1; specifically, it is disposed over the entire area constituted by this side. The layer 3 therein can be configured such that is covers at least the entire perforated area of the supporting layer 1.

The intermediate layer 2 is in contact with the nonwoven part side of the layer 3 and not sintered to the same.

The expanded metal part 5 of the layer 3 as shown in FIG. 2 is not true to scale. The same is flat-rolled and has, for example, in the unrolled state thereof a rhomboid void shape having a bar width of 0.4 mm and a void length of 1.8 mm at a void width of 1.6 mm, wherein, advantageously, a flat-rolled, particularly square-shaped void, expansion metal part is inserted having a void length in the range of approximately 1.8 mm to approximately 2.2 mm and a void width in a range of approximately 1.3 mm to approximately 1.6 mm. The free cross-section F_{q} of the flat-rolled expanded metal is approximately 50%. The expanded metal part 5 can be constituted of the alloy 316L, same as the nonwoven part of the layer 3.

The layer 3 can be followed by a clamping jacket 4, which can be basically constituted of a perforated sheet metal or, alternatively, another metallic fabric. The nonwoven part of the layer 3 can, furthermore, also have more than one layer, preferably of randomly laid-down fibers, wherein the individual layers of the nonwoven part of layer 3 can have different fiber diameters therein, preferably in a range of approximately 1.8 μm to approximately 25 μm.

A layer 3 according to the invention consisting of a nonwoven part with a support part 5 in form of an expanded metal that is connected to at least one partial region of at least one side of the nonwoven art was produced as follows:

Produced was a single-layered nonwoven part of randomly laid down fibers of a diameter of 12 μm (±10%) and a length of approximately 10 mm to approximately 40 mm (±10%) of the iron alloy 316L, wherein the fibers were drawn in bundles. The random-fiber aggregate having a strength of 2 mm prior to sintering (after sintering approximately 0.4 mm) was then subjected to a thermal treatment by sintering in order to interconnect the individual fibers; sintering therein occurred in a vacuum at a temperature of approximately 1,200° C. Afterwards, the metal-fiber nonwoven part constituted thus by sintering was connected to a rolled expanded metal part also consisting of the iron alloy 316L. The flat-rolled, meaning calendered, expanded metal part therein featured an open area/free cross-section of approximately 50%, a void length of approximately 1.8 mm, and a void width of approximately 1.6 mm with a bar thickness of approximately 0.4 mm and a bar with of approximately 0.4 mm. The flat-rolling action of the expanded metal part occurred by means of a calender 6 having two metal roller 7.1, 7.2, opposite in terms of their rotation, with a smooth surface and appropriately adjusted gap for the expanded metal part to be flat-rolled. Sintering of the nonwoven part with the expanded metal part occurred adhering to the previously indicated sintering parameters. However, by way of an alternative, it can be provided that the layer 3 is produced in a single sintering step in that the expanded metal part is placed on top of the random-fiber aggregate. In the example herein, the expanded metal part covers the entire area of one side of the nonwoven part, while, on the other hand, the opposite side of the nonwoven part was not connected to the expanded metal part, particularly by sintering. Within the meaning of the present invention, this is also possible, however, for the intermediate layer 2 and the layer 3 to be connected according to FIG. 1. In the alternative, within the meaning of the present invention, it can also be provided, for example, that the expanded metal is only disposed by way of multiple bands on one or both sides of the nonwoven part or, however, only in partial regions of one or both sides of the nonwoven part, particularly such regions that can be matched to the perforation in the support layer 1 according to FIG. 1.

Furthermore, in the production of the nonwoven part, a weight per unit area of approximately 140 g/m² to approximately 600 g/m² was adjusted. The produced sintered nonwoven part therein had a porosity of >80%, and the nonwoven part produced in this manner with connected expanded metal part, which was disposed across the full area on one side, also had a porosity >80% relative to the nonwoven part. The porosity of the nonwoven part is advantageously not lowered by the interconnection with support part within the meaning of the invention. The throughflow, as measured at a differential pressure of 200 Pa, of layer 3 with a flat-rolled, meaning calendered, expanded metal part and the nonwoven part sintered thereto as described above is upon calendering of the expanded metal part to approximately 0.4 mm, meaning the bar thickness, approximately 500 l/(dm²*min).

Consequently, the present invention provides a filter system that lends itself to being used successfully in connection with, for example, filtering devices as disclosed according to EP 0 058 656 B1 and that has a particularly long service life.

1. A filter system having at least one layer that is permeable for a medium to be filtered (3), comprising at least one nonwoven part and at least one support part (5) made of expanded metal or perforated sheet metal, which is welded or sintered to at least a partial region of at least one side of the nonwoven part, and at least one further layer (1, 2, 4), wherein the support part (5) is disposed on the side of the nonwoven part that is directed away from supporting layer (1) or toward the same.

2. The filter system according to claim 1, characterized in that the support part (5) is flat-rolled.

3. The filter system according to either of the claim 1 or 2, characterized in that the support part (5) is configured as an expanded metal part with a void length in a range of approximately 0.08 mm to approximately 5 mm.

4. The filter system according to any one of the previous claims, characterized in that the support part (5) and/or the nonwoven part is/are constituted of a material that is selected from the group consisting of iron- and/or nickel-containing alloys.

5. The filter system according to any one of the previous claims, characterized in that the nonwoven part is a nonwoven part including oriented and/or randomly laid-down fibers.

6. The filter system according to claim 5, characterized in that the nonwoven part is made of one or multiple layers of randomly laid-down fibers.

7. The filter system according to either of the claim 5 or 6, characterized in that the randomly laid down fibers have different fiber diameters.

8. The filter system according to any one of the previous claims, characterized in that the same further includes at least one intermediate layer (2), preferably made of expanded metal, and/or at least one outer layer (4) constituting a clamping jacket.

9. The filter system according to any one of the previous claims, characterized in that the supporting layer (1) is configured as a perforated jacket.

10. A method for the filtration of viscose, characterized in that a medium that is to be filtered is supplied to a device and passed through a filter system, which is allocated to the device, according to any one of the claims 1 to 9, and circulated out of the device.

11. The method according to claim 10, characterized in that the device is configured as a backflush filter, particularly an automatic backflush filter.

12. The method according to any one of the claim 10 or 11, characterized in that a medium that is to be filtered is supplied to the filter system at a temperature of approximately 10° C. to approximately 55° C. inside the device.

13. The method according to any one of the claims 10 to 12, characterized in that the same is implemented by a filter system, wherein the permeable layer (3) has a throughflow, measured at a differential pressure of 200 Pa, that is in the range of approximately 40 l/(dm²*min) to approximately 900 l/(dm²*min).

14. A device for the filtration of viscose according to any one of the claims 10 to 13, comprising a filter system according to any one of the claims 1 to 9.

15. A use of a filter system having at least one layer that is permeable for a medium that is to be filtered (3) comprising at least one nonwoven part and at least one support part (5) of expanded metal or perforated sheet metal, which is welded or sintered to at least a partial region of at least one side of the nonwoven part inside a device for the filtration of viscose, or a method for the filtration of viscose.
